(19) United States
(12) Patent Application Publication
(10) Pub. No.: US 2014/0200913 A1
(43) Pub. Date: Jul. 17, 2014

(54) Method, System, And Apparatus For Providing Remote Healthcare

(71) Applicants: Sunil Budhrani, Vienna, VA (US); Shahin Korangy, Potomac, MD (US)

(72) Inventors: Sunil Budhrani, Vienna, VA (US); Shahin Korangy, Potomac, MD (US)

(21) Appl. No.: 14/101,290

(22) Filed: Dec. 9, 2013

Related U.S. Application Data
(60) Provisional application No. 61/736,516, filed on Dec. 12, 2012.

(51) Int. Cl. G06Q 50/22; G06Q 10/10

(52) U.S. Cl. CPC G06Q 50/22; G06Q 10/10
USPC 705/2

(57) ABSTRACT

A method, system and apparatus for delivering remote healthcare via a communication network.

### CROSS-REFERENCE TO RELATED PATENT APPLICATION

This application claims the benefit under 35 U.S.C. §119(e) of U.S. Provisional Patent Application. No. 61/736,516, filed on Dec. 12, 2012 in the U.S. Patent and Trademark Office, the entire disclosure of which is hereby incorporated by reference.

### FIELD OF THE INVENTION

The present application relates to a method, system and apparatus for providing remote healthcare. Particularly, the present invention provides for a comprehensive solution for delivering healthcare via a communication network.

### BACKGROUND OF THE INVENTION

Conventional healthcare approach required that a healthcare recipient (such as a patient) be at the same geographical location as the healthcare provider (such as a doctor), at the time of the providing healthcare services provided by the provider to the recipient. For example, for an in-person/face-to-face medical session/consultation, a patient was required to be at the same geographical/physical location as the doctor at the time of providing the medical service to the patient, such that the doctor would/could physically observe, examine and make contact with the patient. This required the patient to be within a physical proximity of the doctor (such as in the same room) so that the doctor could physically make contact (ie., touch, smell, and/or physically observe) the patient, with or without healthcare instruments. For example, in the conventional approach, if a patient needed medical services, the patient was required to visit the doctor's office or the doctor visited the patient's location (such as patient's home). For the doctor to personally examine the patient, the patient was required to be in physical proximity of the doctor at the same time. If the doctor needed to examine the patient physically, the doctor made physical contact with the patient, with or without utilizing instruments, and recorded the results on in a patient's medical record (file).

To diagnose a patient's medical condition, a doctor (and/or doctor's staff) would conduct a myriad of observations and/or test, with or without instruments. For example, to gauge a patient's body temperature, the doctor may have touched the patient to feel the patient's approximate body temperature, and/or use a thermometer to get a more accurate reading. To listen to a patient's heartbeats, a doctor would use a stethoscope on the patient and write down the results. To feel the patient's pulse, the doctor (or doctor's staff) would place their fingers on the patient's wrist and count the pulses. To gauge a patient's blood pressure, the doctor (and/or doctor's staff), would read the blood pressure by applying blood pressure measuring instruments onto the patient. All of these and/or other observations, using the conventional approach, required the doctor (and/or doctor's staff) to be physically in the same place at the same time as the patient.

The conventional healthcare system was inflexible, expensive, inefficient and cumbersome, by requiring the medical recipient (patient) and medical provider (doctor) to physically be at the same location at the same time. For example, if a patient was not physically near a doctor at a time of need, the patient had to make an appointment with a doctor or visit and emergency room at a hospital (which significantly and unnecessarily increased the cost for addressing that specific medical issue). If the patient had to make an appointment with a doctor for some time in the future, the symptoms may have gone away and no longer be observable, and thus making the doctor's visit moot (for example a rash). In another scenario, if a patient needed to visit a specialist doctor (such as a cardiologist) but that specialist was (hundreds of) miles away, the patient would have to be transported to the specialist (via ambulance, automobile, air lift, . . . ), thus increasing the time and cost prior to and in addition to the specialist's service. In addition to high monetary cost and inconveniences, the physical and temporal proximity requirement, according to conventional medical care systems, could proved to be fatal to a medical recipient. For example, if a general doctor (non-specialist) was observing a patient experiencing traumatic medical condition, and the general doctor did not have experience in handling the traumatic condition, then the patient would have been required to be transported to another specialist doctor at a different geographic location, thus increasing the time and cost before the patient received any medical service. In another scenario under the conventional healthcare system, if a child was feeling sick in the middle of the night (or anywhere away from a doctor's office such as at home, school, or on travel), then the child's parent or caretaker was required to take the child to visit a doctor (in an office, or a hospital) to get medical attention for the child. Once a doctor examined the child, the doctor prescribed medication for the child to pick up from a third-party pharmacy (which may require traveling to a pharmacy). Further, if the parent initially did not take the child to the appropriate medical provider for treating the child's specific illness, then the child would have been transported to another medical provider. In this conventional scenario, the sick child would have had to travel from home to a doctor for receiving medical attention, thus further aggravating the child's sickness, and prolonging the time until the child received the appropriate treatment of the illness.

Additionally, conventional healthcare systems required that a medical provider to maintain a medical record/file for each medical recipient patient. Conventional systems used a physical file for each patient comprising of medical observations for the patient (such as doctors notes, observations, x-rays, measurements, and any other information maintained by a medical provider for a patient). By maintaining a physical file for a patient, the conventional systems were inflexible, inconvenient, and expensive to maintain. For example, if a patient visited another medical service provider than the one that possessed the physical file for the patient, then the file would have to be transported to the other medical service provider. Maintaining a physical file for each patient required physical space for a medical service provider, which became cumbersome and expensive to a medical service provider. Maintaining a physical file also increased the risk of damage, loss, theft, and/or overall insecurity of the patient's medical file, in addition to numerous other disadvantages. Additionally, if a patient traveled away from the medical provider that maintained their medical file, then the patient would have been limited in receiving medical service while traveling because the medical file would be inaccessible while traveling.

Embodiments of the present invention address at least the drawbacks associated with conventional healthcare system and approaches.

### SUMMARY OF THE INVENTION

As noted above, exemplary embodiments of the present invention address at least the above problems and/or disadvantages, and provide at least the advantages described below. Exemplary embodiments of the present invention provide a method, system and apparatus for delivering healthcare services that does not require a healthcare recipient to be at the same geographical location the healthcare provider at the time of the services For example, a doctor is not required to be at the same geographical location as a patient at the same time, in order to provide healthcare services to the patient. Exemplary embodiments of the present invention provide for a method, system and apparatus such that a healthcare service provider can be geographically remote from the healthcare service recipient at the time of providing the healthcare services. A healthcare services provider can deliver services to a healthcare recipient regardless of whether the recipient is at the same geographical location as the doctor at the time of the medical service. According to various scenarios of an exemplary embodiment of the present invention, a doctor can be in another state than the patient, in another room of the same building than the patient, or be in the same room as the patent. Exemplary embodiments of the present invention provide a method, system and/or apparatus to store an electronic medical record (“EMR”) and/or a personal health record (“PHR”) for each healthcare recipient such that information from the healthcare services is stored and maintained in the EMR/PRH.

Exemplary embodiments of the present invention provide a method, system and apparatus for providing a comprehensive doctor-patient medical consultation that is substantially similar (or equal) to an in-person healthcare consultation. Additionally, by utilizing the method, system and/or apparatus according to exemplary embodiments of the present invention, a doctor that is geographically remote from a patient can perform medical functions on a patient as if the doctor was geographically with the patient at the time of the performing the functions. Utilizing an exemplary embodiments and/or implementation of the present invention, a comprehensive healthcare consultation is provided by a healthcare provider to a healthcare recipient, where the consultation is considered an in-person consultation even though the healthcare provider and recipient are geographically remote from one another at the time of the consultation.

According to various exemplary embodiments and/or implementations of the present invention, the method, system and/or apparatus provide secure real-time (or near real-time) communication (over a computer implemented network) of a healthcare session between one or more healthcare provider(s) and/or one or more healthcare recipient(s), and related medical information, without requiring the provider(s) and recipient(s) to be geographically together at the same time.

An exemplary embodiment of the present invention provides a method, system and apparatus for establishing a secure real-time healthcare session between a doctor and a patient and storing all the medical information from the session. Exemplary embodiments and/or implementations of the present invention provide a non-transitory computer implemented platform, to record and maintain an electronic medical record (“EMR”) related to a healthcare recipient (such as a patient) to facilitate delivery of healthcare services by a healthcare provider (such as a doctor) to a healthcare recipient that is remote from the provider at the time of the healthcare service. Exemplary embodiments and/or implementations of the present invention provide a computer-implemented platform for storing and maintaining information a confidential EMR on an electronic storage accessible, via a secure telecommunication network, to a healthcare recipient, a healthcare provider, and/or any authorized user/entity (such as insurance company, healthcare organization, pharmacy, . . . ). For example, a patient seeking medical services/consultation can log onto the system and provide personal and vital information related to the patient for medical services to the system of the present invention. The exemplary system of the present invention creates and maintains an EMR related to the patient. A healthcare provider/doctor logs onto the exemplary system of the present invention and accesses the EMR of the patient for providing healthcare services. The healthcare recipient and provider are logged onto the system, via an authorized secure computer implemented network connection. As such, the patient and doctor can be connected in real-time (or near real-time) for a medical consultation, while the information from the consultation is stored in the patient's EMR, using the method, system and/or apparatus according to the present invention.

According to various embodiments and/or implementations of the present invention, the EMR comprises a plurality of information related to providing healthcare services to a recipient. For example, the plurality of information comprises at least one answer that the recipient user provides, data (i.e., vital signs, bodily statistics, . . . ) gathered by a medical device (such as blood pressure machine, heart rate monitor, diabetes monitor, temperature monitor, . . . ), data from other medical providers (i.e., doctors, scientists, laboratories, pharmacy, customer service), an audio recording, and/or a video recording (such as a digital camera, a telephone camera, web-cam, . . . ), at the recipient location. The exemplary method, system and/or apparatus according to the present invention provide for storing and managing the plurality of information in the recipient EMR stored in the encrypted database management storage system.

According to a various exemplary embodiments of the present invention, an EMR for a patient maintains observations related to a patient (such as an xray, blood reports, vital signs, etc.) which can be electronically accessed by one or more authorized healthcare provider via a secure electronic communication network, at a later time for providing medical consultation/services related to the patient. For example, one or more healthcare providers can access a patient's EMR to examine the information stored in the EMR for rendering healthcare services.

Exemplary embodiments and/or implementations of the present invention provide for various advantages, benefits, and features. For example, the method, system and/or apparatus according to the present invention provide for reducing out-of-network provider visits and costs; reducing utilization of health care resources; improving access to physicians and patients; utilizing preventive care; monitoring and tracking heath care services utilization; and promoting dissemination of medical education.

### BRIEF DESCRIPTION OF THE DRAWINGS

The above and other exemplary features, aspects and advantages of the present invention will become more apparent from the following detailed description of certain exemplary embodiments thereof when taken in conjunction with the accompanying drawings in which:

FIG. 1 is a schematic block diagram that illustrates architecture of a healthcare delivery system associated with a method, system and apparatus of the present invention, according to an exemplary embodiment of the present invention.

FIG. 2 is a schematic block diagram that illustrates a healthcare server associated with a method, system and apparatus of the present invention, according to an exemplary embodiment of the present invention.

FIG. 3 is a schematic block diagram that illustrates a healthcare delivery system associated with a method, system and apparatus of the present invention, according to an exemplary embodiment of the present invention.

FIG. 4 is a schematic block diagram that illustrates a communication session associated with a method, system and apparatus of the present invention, according to an exemplary embodiment of the present invention.

FIG. 5 is a schematic block diagram that illustrates a healthcare examination session using an examination station on the healthcare delivery system associated with a method, system and apparatus of the present invention, according to an exemplary embodiment of the present invention.

FIG. 6 is a schematic block diagram that illustrates a healthcare examination station associated with a method, system and apparatus of the present invention, according to an exemplary embodiment of the present invention.

FIG. 7 is a graphical user interface in a healthcare delivery system associated with a method, system and apparatus of the present invention, according to an exemplary embodiment of the present invention.

FIG. 8 is a graphical user interface in a healthcare delivery system associated with a method, system and apparatus of the present invention, according to an exemplary embodiment of the present invention.

FIG. 9 is a graphical user interface in a healthcare delivery system associated with a method, system and apparatus of the present invention, according to an exemplary embodiment of the present invention.

FIG. 10 is a graphical user interface in a healthcare delivery system associated with a method, system and apparatus of the present invention, according to an exemplary embodiment of the present invention.

FIG. 11 is a schematic block diagram that illustrates a healthcare examination station associated with a method, system and apparatus of the present invention, according to an exemplary embodiment of the present invention.

FIG. 12 shows a healthcare monitoring system comprising one or more recipient monitoring devices coupled to a recipient terminal, and connected to a provider terminal via the server, according to an exemplary embodiment of the present invention.

FIG. 13 shows a healthcare monitoring session 1300 between one or more recipient monitoring devices, and at least one healthcare provider terminal via the server, according to an exemplary embodiment of the present invention.

FIG. 14 shows a flow diagram of an examination session between a recipient and a provider, according to an exemplary system, method and apparatus of the present invention.

Throughout the drawings, like reference numerals will be understood to refer to like elements, features and structures.

### DETAILED DESCRIPTION OF EXEMPLARY EMBODIMENTS

The matters exemplified in this description are provided to assist in a comprehensive understanding of exemplary embodiments of the present invention described with reference to the accompanying drawing figures. Accordingly, those of ordinary skill in the art will recognize that various changes and modifications of the exemplary embodiments described herein can be made without departing from the scope and spirit of the present invention. Also, descriptions of well-known functions and constructions are omitted for clarity and conciseness. Likewise, certain naming conventions, labels and terms as used in the context of the present disclosure are, as would be understood by skilled artisans, non-limiting and provided only for illustrative purposes to facilitate understanding of certain exemplary implementations of the embodiments of the present invention.

Exemplary embodiment and/or implementation of the present invention provide a non-transitory computer implemented method, system and/or apparatus, to facilitate delivery of healthcare services to a healthcare recipient by a healthcare provider.

A healthcare service, according to an exemplary embodiment and/or implementation of the present invention, comprises a healthcare consultation, session, examination, and/or function.

A healthcare recipient, according to an exemplary embodiment and/or implementation of the present invention, comprises a patient and/or anyone receiving healthcare services.

A healthcare provider, according to an exemplary embodiment and/or implementation of the present invention, comprises a doctor, the doctor's staff such as a nurse, medical assistant, technician, physician's assistant, intern, and/or anyone else working related to providing healthcare.

A healthcare instrument/device, according to an exemplary embodiment and/or implementation of the present invention, comprises any medical device used to assist diagnosing/treating a recipient (such as a stethoscope, heart rate monitor, station with multiple devices, blood sugar monitor, . . . ). A healthcare instrument/device comprises instruments/devices that are electronically connected (wired or wireless) to a recipient's terminal, a provider's terminal, and/or capable of being connected to a computer implemented terminal (for example, a Bluetooth connection). A healthcare instrument/device that is wirelessly connected to a terminal, sends/receives command and/or data signals to/from a computer terminal. For example, a stethoscope can be connected to a recipient's terminal via a wired connection or wirelessly connected to the recipient's terminal via a wireless signal (such as Bluetooth), and send/receive data/commands obtained by the stethoscope to the recipient's terminal.

A healthcare organizational entity, according to an exemplary embodiment and/or implementation of the present invention, comprises a hospital, medical insurance company, university, medical center, clinic, doctor's office, and any other organization or group related to healthcare.

A healthcare third-party provider, according to an exemplary embodiment and/or implementation of the present invention, comprises a pharmacy, laboratory, and any other party related to provide a product or service to support healthcare (such as blood test, prescription medication, xrays, . . . )

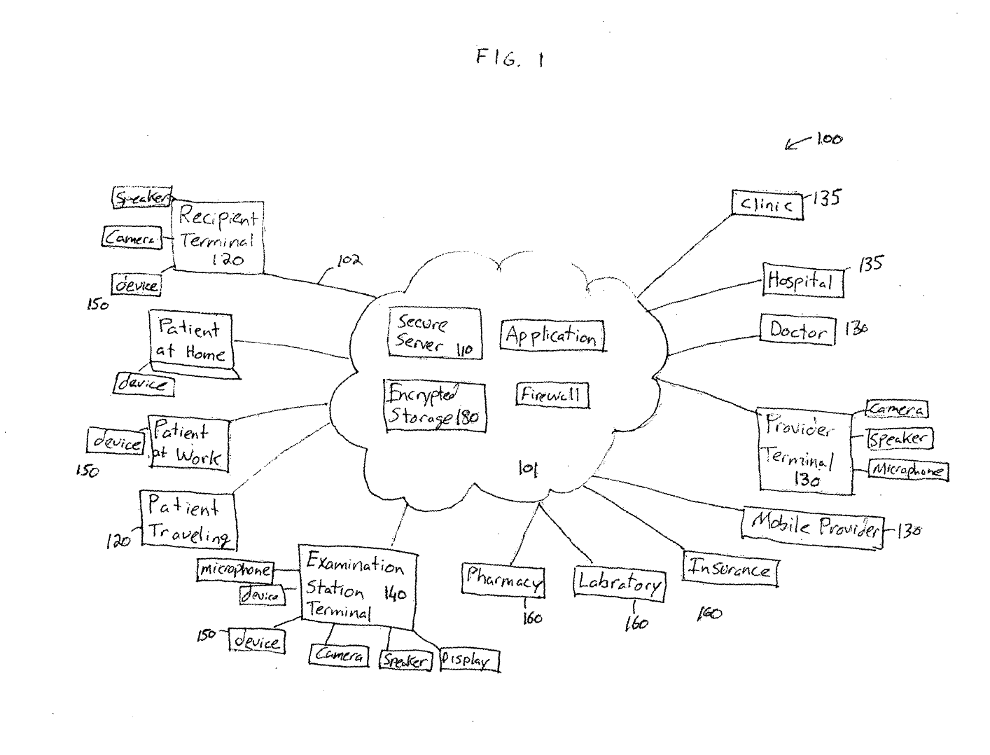

FIG. 1 shows a healthcare delivery system 100 according to an exemplary embodiment of the present invention comprising a healthcare management system 101 comprising a central healthcare server 110 connected, via a telecommunication network 102 (such as Internet/Intranet), to one ore more recipients and/or providers. For example, server 110 established connection with one or more of a healthcare recipient terminal 120, a healthcare provider terminal 130, a healthcare examination station terminal 140, medical instrument/device(s) 150, a healthcare organizational entity terminal 135, and a healthcare third-party entity terminal 160. Server 110 establishes healthcare sessions between/among one or more of said terminals (described below). For example, server 110 establishes an examination session between a patient on a recipient terminal 120 and a doctor on a provider terminal, wherein the session is a live (or near-live) interactive virtual private network connection between the patient and the doctor. Additionally, the server 110 establishes a session between the server and at least one terminal. For example, a patient on a recipient terminal can establish a session on the server to view patient's personal health records. A pharmacist on a third party entity terminal 160 establishes a session with the server to view/edit/add a patient's pharmacy related information from the patient's electronic medical record. A laboratory on a third party entity terminal 160 establishes a session with the server to view/edit/add a patient's laboratory related information in the patient's electronic medical record.

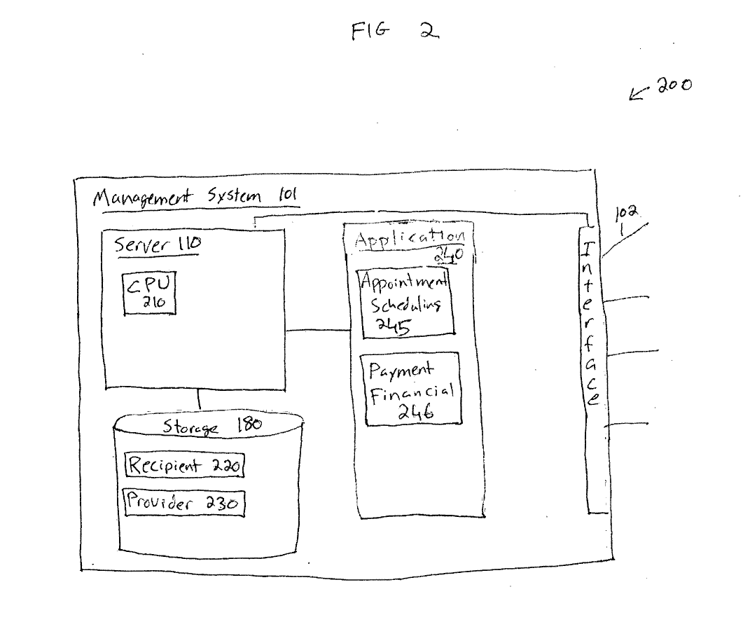

FIG. 2 shows a healthcare deliver system, method and/or apparatus 200, according to an exemplary embodiment of the present invention, comprising a healthcare management system 101 comprising a central healthcare server 110 (including one or more processors such as central processing unit (CPU) 210, and/or microprocessor(s)) connected to an data storage 180 (comprising a healthcare recipient database 220, a healthcare provider database 230), an applications module 240 (comprising appointment/scheduling module 245, payment/financial, and other application modules), and/or one or more communication interfaces to communicate with an electronic communication network 102 (to communicate with a recipient terminal, a provider terminal, a examination terminal, a medical device, a healthcare third-party entity, a healthcare organizational entity).

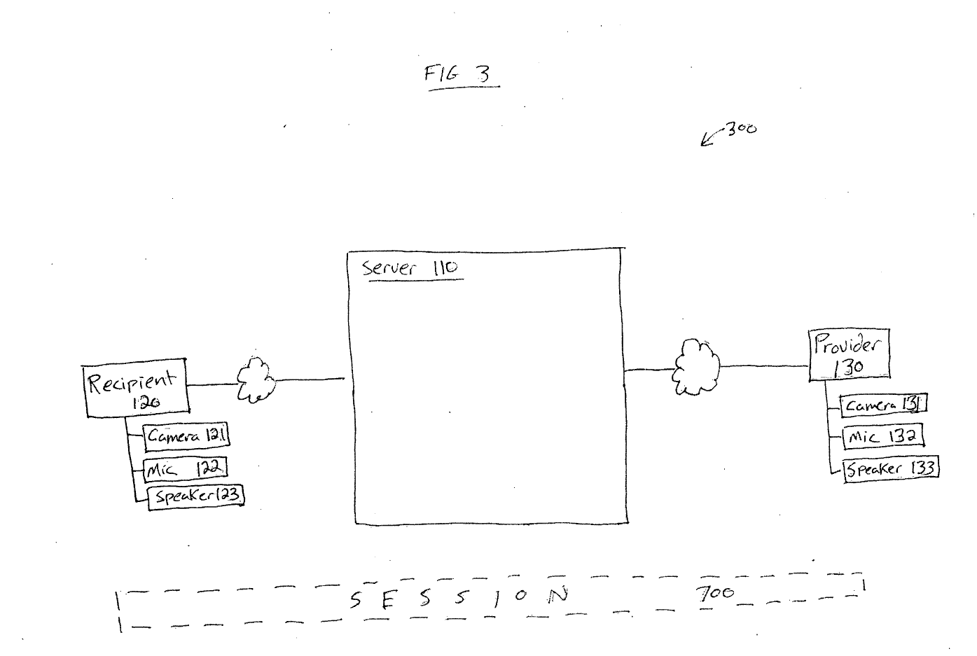

FIG. 3 shows a healthcare delivery system, method and/or apparatus 300 according to an exemplary embodiment of the present invention comprising a central healthcare server 110, a healthcare recipient terminal 120, and one or more healthcare provider terminal 130, such that a secure healthcare examination session 700 is established between the recipient terminal 120 and provider terminal 130, via the server 110. According to an exemplary embodiment of the present invention, the recipient terminal and provider terminal are connected to the server via a telecommunication network 102 (such as Intranet/Intranet) such that the server 110 sends/receives information to/from the recipient terminal and provider terminal. According to an exemplary embodiment of the present invention, the recipient terminal 120 (e.g., laptop, desktop, tablet, smartphone, etc) comprises a camera 121 (e.g, web-camera), an audio microphone 122 to receive voice/audio from the recipient at the terminal, and an audio speaker 123 to play voice/audio to the recipient at the terminal. The provider terminal 130 (e.g., laptop, desktop, tablet, smartphone, etc.) comprises a camera 131 (e.g., web-camera), an audio microphone 132 to receive voice/audio from the provider at the terminal, and an audio speaker 133 to play voice/audio signals to the provider at the terminal. The cameras 121 131, microphones 122 132, and speakers 122 132 facilitate an audio/video communication session during a healthcare examination session 700 established between a recipient and a provider, via the server. When a secure session 700 is established between a recipient 120 and a provider 130, via the server 110, a graphical user interface is generated (such as an Internet browser)(shown below) at the provider terminal that shows a real-time/live (or near real time/live) video images from the recipient terminal along with respective audio; and simultaneously, a graphical user interface is generated (such as an Internet browser)(shown below) at the recipient that shows a real-time/live (near real-time/love) video images from the provider terminal(s) securely connected in the session along with respective audio. The examination session 700 simulates an in-person/face-to-face doctor-patient session/visit/consultation as if the doctor was conducting a healthcare examination session physically in the presence of the patient.

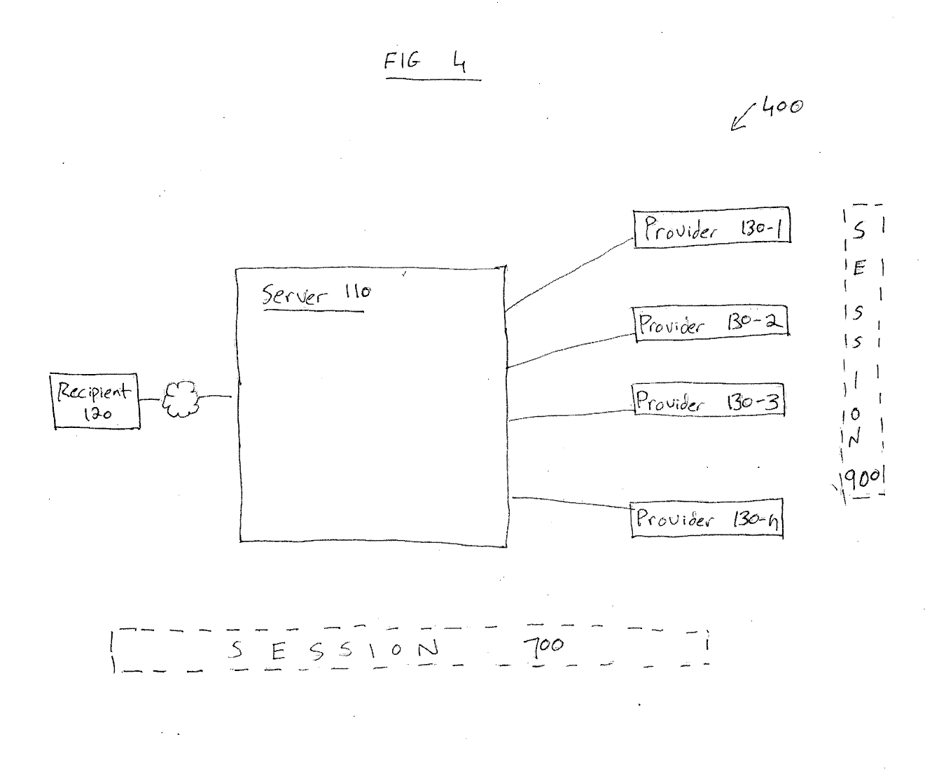

FIG. 4. shows a healthcare delivery system, method and/or apparatus 400 according to an exemplary embodiment of the present invention, comprising a central healthcare server 110 electronically connected to one or more healthcare provider terminal 130-1, 130-2, 130-3, . . . 130-n, and a recipient terminal 120. The server 110 in delivery system 400 establishes a secure, confidential healthcare examination session 700 between a recipient and at least one provider (simulating an in-person/face-to-face doctor-patient visit) as if the recipient was physically in the presence of each of the provider(s), by establishing a secure, confidential electronic communication session between the recipient terminal 120 and one or more provider terminals 130, 130-1, 130-2, 130-3, . . . 130-n, via a communication network 102.

Further, in FIG. 4 shows a consultation session between/among a plurality of provider terminals 130-1, . . . 130-n, established via server 110, according to another exemplary implementation of the present invention. Server 110 in healthcare delivery system 400 establishes a secure, confidential healthcare consultation session 900 between/among one or more providers terminals (130-1 . . . 130-n), which may or may not include a recipient 120. For example, simulating an in-person/face-to-face doctor-to-doctor consultation session among doctors.

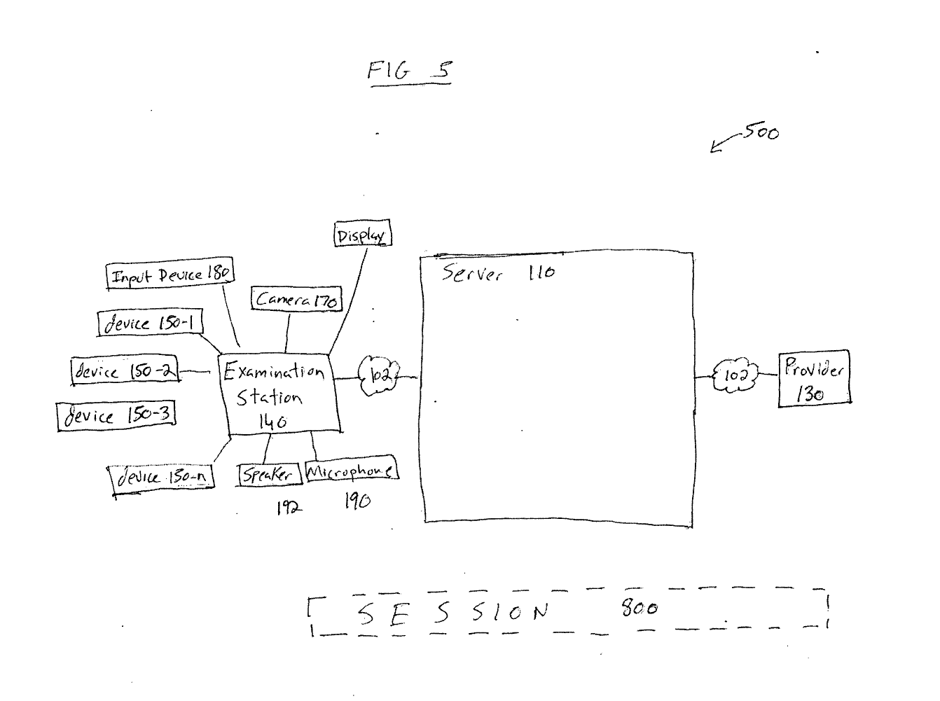

FIG. 5 shows healthcare delivery system 500 according to an exemplary embodiment of the present invention comprising a central healthcare server 110 electronically connected to a healthcare examination station 140 and to one or more healthcare provider terminal(s) 130 over an electronic communication network (such as Internet/Intranet) 102, such that a secure healthcare examination session 800 is established, via the server, between the examination station 140 and provider terminal(s) 130 upon authentication. The station 140 is coupled to one or more medical instruments/devices 150-1, 150-2, 150-3, . . . 150-n, one or more video cameras 170, one or more microphones 190, and/or one or more speakers 192. The server 110 in system 500, establishes a secure, confidential healthcare examination session 800 (simulating an in-person/face-to-face doctor-patient visit) as if the recipient is physically in an examination room with the providers, by establishing a secure, confidential electronic communication session between a provider terminal 130 and an examination station 140.

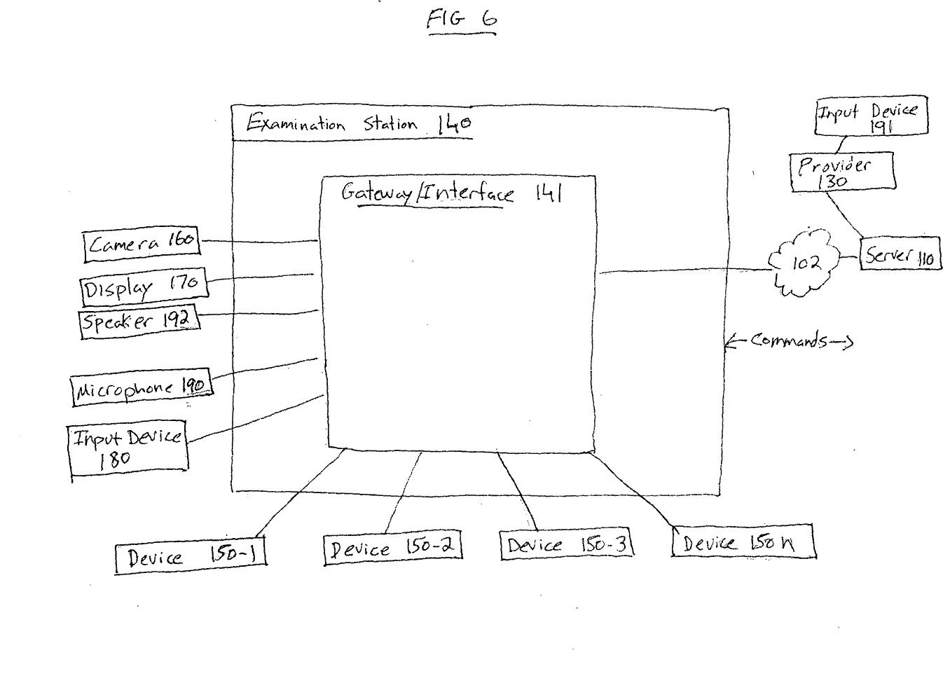

FIG. 6 shows a healthcare examination station 140 according to an exemplary embodiment of the present invention comprising a healthcare devices gateway/interface 141 coupled to one or more medical devices 150 (150-1, 150-2, 150-3, 150-4, . . . 150-n), one or more video camera devices 160, one or more display devices 170, one or more user input devices (such as mouse, joystick, and/or keyboard) 180, and/or one or more audio devices (microphone 190, speaker 192), via a wired or wireless connection. The gateway 141 is connected to the healthcare server 110 via a telecommunication network 102 such as to send and/or receive data and command signals to/from the server 110. The examination station 140 comprises one or more cameras that capture video images of a recipient's examination. These video images are displayed at a display device 170 at the station 140 in real-time, transmitted/sent to the server 110, and displayed at the provider terminal in real-time/live (or near real-time/live) for simulating an in-person face-to-face healthcare session between the examination station and the healthcare provider. According to an exemplary embodiment of the present invention, when the video images are transmitted to the server, the video images are stored in the recipient's EMR (discussed below) in the recipient's data storage 220, via the server. Additionally, the provider terminal 130 comprises/interfaces with one or more provider input devices 191 (such as a mouse, joystick, and/or keyboard, etc.) to receive a provider command signals to control functions at the examination station, via the server 110. The provider terminal receives a provider command signal from a provider user via the provider input device 191, transmits the provider command signal to the examination station via the server. The examination station gateway sends the provider command signal to the appropriate medical device 150 to execute the command signal(s). The command signal comprises one or more to control functions of the medical devices and/or camera for a remote provider to control the devices/camera to execute commands at the examination station, via the server 110. For example, a provider, connected to the examination station during a session with a recipient, can control the video camera(s) and/or devices mounted on the examination station by sending command signals. If a doctor wants to zoom the camera in closer to a patient's body part, the doctor can send a command (such as a joystick command) to zoom the camera. The command signals comprise data and/or power control signals.

Additionally, the medical devices 150 and/or cameras 160 that are connected to the examination station can be controlled by a human operator to facilitate a healthcare session, with or without command signals by a provider. For example, a nurse or technician can control the functions of the devices 150 and camera 160 connected to the station, and transmit the audio recordings, video images and/or data gathered from the devices to the server, for facilitating a session with a provider. A provider connected to the station for a healthcare session via the server, can send audio signals (comments, inquiries, command instructions) through a microphone at the provider's terminal such that the examination station receives the provider's audio signals from the server, and facilitates a speaker at the station to play the audio signals sent by the provider via the server. An examination operator at the station (e.g., a doctor, nurse, technician, . . . ) can operate the devices and/or camera coupled to the station based on the instructions from the provider during the healthcare session, if there are any instructions sent. This provides the benefit of simulating an in-person healthcare session as if the provider was conducting the physical examination of the patient in the same location.

For example, during a doctor-patient session via the server according to an embodiment of the present invention, if the doctor wants to get a stethoscope reading of the patient, but the doctor is geographically remote from the patient, the doctor can instruct an examination operator to examine the patient with the stethoscope. The operator examines the patient with the stethoscope connected (wired or wirelessly) to the examination station. The results of the stethoscope examination are transmitted in real-time (or near real-time) to the doctor, via the server, and are recorded in the patient's EMR stored in the database at the server. During the same session, in addition to the stethoscope examination, the remote doctor can control the camera at the station (for example, to zoom in/out) to do a visual examination of the patient, in real-time (or near real-time), via the server. Using the camera at the examination station, the remote doctor can capture still and moving images of the patient, and store the images in the patient's EMR in the database at the server. The doctor can send command signals to the station at the same time that the devices on the station are performing their respective functions on the patient. This allows the benefit of the doctor simultaneously examining the patient while the devices are performing their functions, during a doctor-patient session.

The examination station 140 comprises interfaces to couple with any compatible medical device 150 that can integrate with the station (such as via a gateway connected to the server via a communication network). For example, a medical device 150 coupled with the station 140 comprise one or more of a stethoscope, heart rate monitor, pulse oximetry, glucometer, spirometer, scale(s), thermometer, blood pressure machine, heart rate monitor, diabetes monitor, temperature monitor, and any other device that can integrate with the station.

Exemplary embodiments of the present invention provide a method, system and apparatus for establishing healthcare sessions on an electronic communication network (such as Internet/Intranet, telecommunication network, Ethernet network, . . . ). A healthcare session comprises establishing a secure and confidential connection (such as a virtual private network (“VPN”)) between/among one or more user terminal accessing the server via the communication network (upon appropriate authentication). A healthcare session can be initiated via any terminal that can access and be authenticated (logged into) the server. For example, the server can establish various healthcare session including but not limited to:

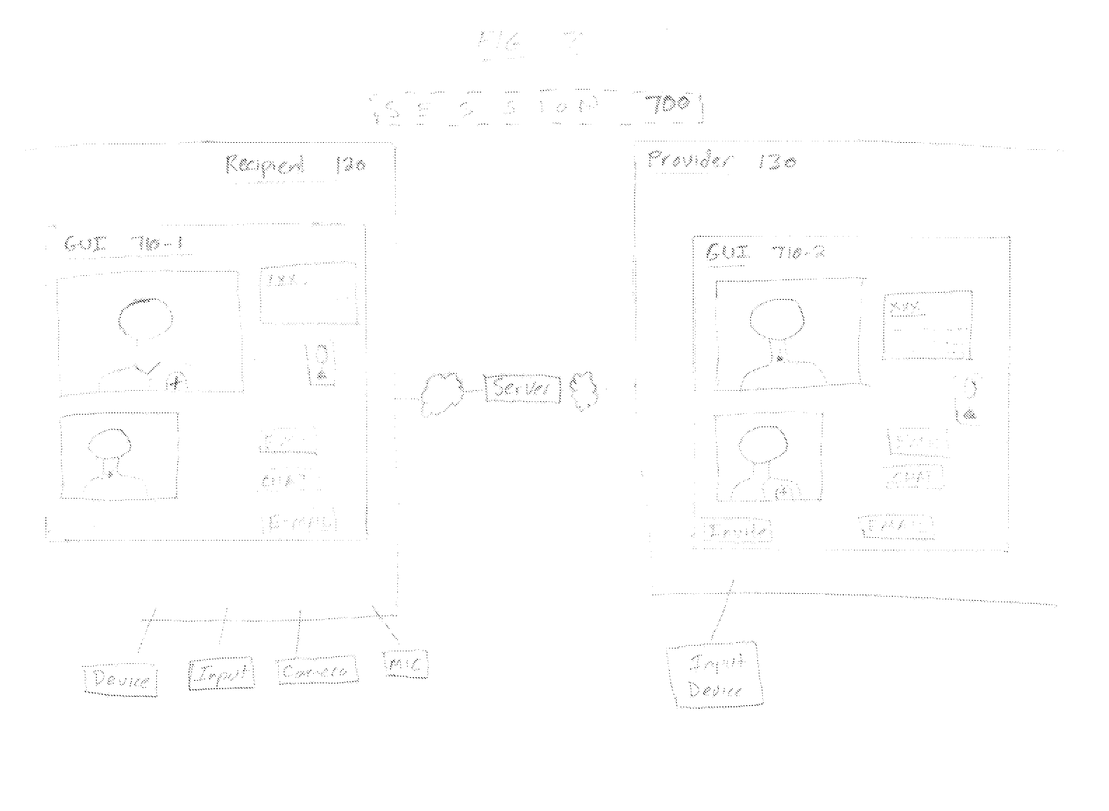

(1) a healthcare examination session between a healthcare recipient terminal and a healthcare provider terminal via the server (FIG. 7),

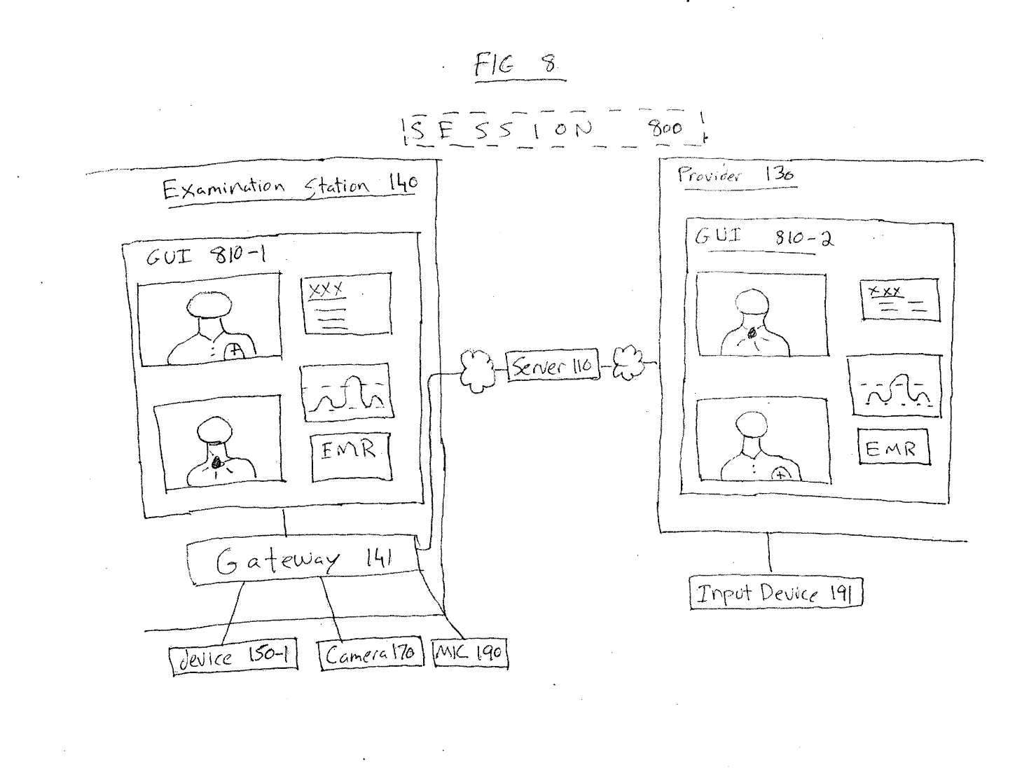

(2) a healthcare examination session between/among a healthcare examination station and one or more healthcare provider terminals via the server (FIG. 8),

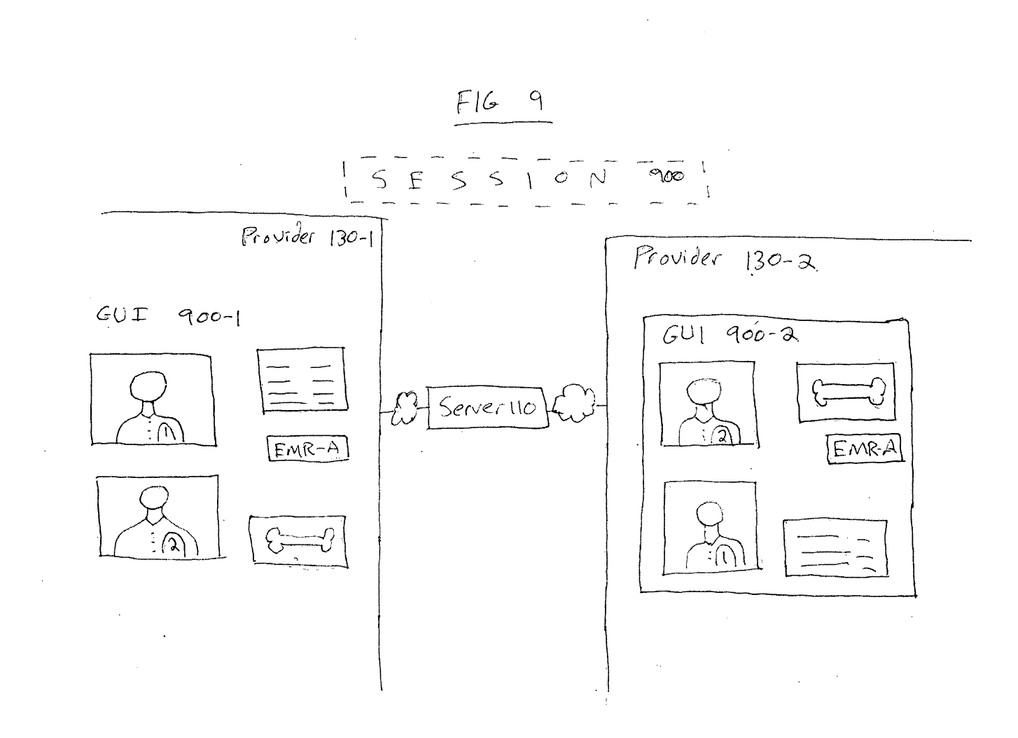

(3) a healthcare consultation session between/among two or more healthcare provider terminals via the server (FIG. 9),

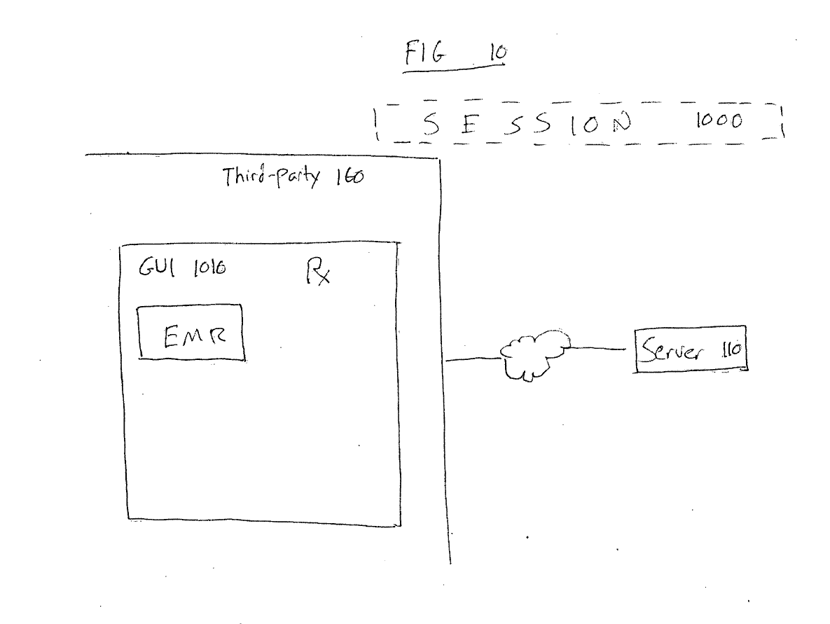

(4) a healthcare service session between a healthcare third-party provider terminal and the server (FIG. 10).

(5) a healthcare monitoring session between a healthcare recipient terminal and at least one healthcare provider terminal via the server.

According to an exemplary embodiment of the present invention, each healthcare session is displayed at the authorized user's terminals in one or more healthcare session window comprising one or more a graphical user interfaces (“GUI”). A healthcare session window comprises an electronic document window (such as a Web browser).

FIG. 7 shows a healthcare examination session 700 between one or more provider terminals 130 and a recipient terminal 120 wherein the server 110 generates one or more graphical user interface(s) (GUIs) 710-1, 710-2 at each respective terminal 120 and 130, according to an exemplary embodiment of the present invention. For example, a GUI showing an examination session is displayed at both, the recipient terminal 120 and the provider terminal 130, in an electronic document such as a Web browser (or an electronic window) comprising all information to simulate a face-to-face interaction between a healthcare provider and healthcare recipient. The browser/window comprises one or more sub-windows or frames to provide various real-time and stored data items related to the examination session, including (but not limited to) a real-time live videoconference between the recipient terminal and the provider terminal. The healthcare examination session includes a real-time videoconference comprising video display of the recipient in the GUI 710-2 at the provider terminal 130, and a real-time video display of the provider in the GUI 710-1 at the recipient terminal 120, with respective audio/sound, administrative information of recipient and provider, EMR data, textual chatting, medical devices data, and any other information related to a medical examination session. At the provider terminal 130, an electronic document 710-2 is displayed showing a live (or near live) video display of the recipient at the recipient terminal, with the recipient's EMR contents and any other functionality necessary for examining a patient during an examination session and to communicate with the patient. At the recipient terminal 120, the electronic document 710-1 is displayed showing a live (or near live) video display of the provider at the provider terminal and the recipient's EMR content, along with any other functionality necessary for examining the recipient during the examination session.

According to an exemplary embodiment of the present invention, the combination of GUI displays 710-1, 710-2 show an interactive examination session 700 between a doctor and patient, as if the patient were physically with the doctor. For example, the server establishes a secure examination session between a patient and a doctor, upon authentication. Upon establishment of an examination session, the server either accesses a previously created EMR for that patient or creates a new EMR for that patient, which is displayed to the doctor and patient in GUI 710-2 and 710-1 respectively. Utilizing an exemplary method, system and/or apparatus of the present invention, the doctor examines the patient using the real-time video camera data received from the patient's terminal, communicates textually or via audio with the patient, observes any data gathered from devices at the patient's terminal, and makes notes/comments. The server stores the various data items related to examination session between the doctor and patient in the patient's EMR (discussed below).

FIG. 8 shows a healthcare examination session 800 between one or more provider terminals 130 and an examination station 140 wherein the server 110 generates one or more graphical user interface(s)(GUIs) 810-1, 810-2 at each respective terminal 140, 130, according to an exemplary embodiment of the present invention. A GUI showing an examination session is displayed at both the examination station 140 and the provider terminal 130, in an electronic document such as a Web browser (or an electronic window) comprising all information to simulate a face-to-face interaction between a healthcare provider and a healthcare recipient using the examination station 140. Upon establishing an authenticated and authorized examination session between the provider terminal 130 and examination station 140 (authenticated for the recipient/patient under examination at the examination station), the server displays GUI 810-1 810-2 including EMR information for the recipient/patient under examination at the examination station, displays one or more sub-window frames within the GUI showing a live (or near-live) video images from the provider terminal 130 and examination station 140, displays sub-window frames for information (data, video, audio) gathered from one or more of the medical devices 150 connected to the examination station 140. GUIs 810-2 810-1 also receive notes, comments, images, pictures, data reports provided by the provider terminal 130 and/or examination station 140, which are stored in the EMR for the patient being examined at the station. For example, a doctor at the provider terminal can make notes, using an input device such as keyboard, mouse, joystick, and/or an electronic pen, and those notes are displayed in the GUI 800 at the recipient terminal and the examination station 140, and are stored in the patient's EMR database at the server.

FIG. 9 shows a healthcare consultation session 900 between/among a plurality of healthcare provider terminals 130-1 130-2, wherein the server 110 generates one or more GUI 900-1 900-2 at each respective provider terminal 130-1 130-2, according to an exemplary embodiment of the present invention. Specifically, upon establishing an authenticated and authorized session between/among a plurality of provider terminals 130 (authorized to access a patient's EMR and/or administrative information stored in the database based on access privileges for the provider terminal), the server displays GUI 900-1 900-2 at respective provider terminals 130-1 130-2 engaged in the consultation session. If a recipient terminal is also engaged in the session 120, as shown in FIG. 4, the similar GUI is also displayed at the recipient terminal. Upon authentication, the server establish a secure, confidential healthcare consultation session between/among two or more provider terminals 130. For example, a healthcare consultation session can be established, by the server, between a general doctor and a specialist doctor to consult about a patient, with or without the patient being included in the session, assuming appropriate authorization. For example, the server can establish a consultation session between a general doctor and a heart specialist doctors such that both doctors can access a patient's EMR during the consultation session and make notes and store further data into the EMR based on the consultation.

Additionally, according to an exemplary embodiment of the present invention, a healthcare consultation session can be established between two or more provider terminals 130, while a patient is physically at one of the provider terminals, and GUI 900 is displayed at the each provider terminal 130. Specifically, upon establishing an authenticated and authorized session between/among a plurality of provider terminals 130-n, the server displays GUI 900-n at the provider terminals engaged in the consultation session 900. If a patient is physically located at a first provider terminal 130 (along with a doctor), then GUI 900-1 displayed at the first provider terminal 130-1 displays access to the patient's EMR. The GUI 900-2 displayed at the other provider terminals 130-2, connected via the server, displays access to the patient's EMR. The GUI 900-1 at the first provider terminal 130-1 and the other provider terminals (such as 130-2) are able to access the patient's EMR based on their access privileges (make notes, delete, add data, control attached medical devices, store information in the EMR, etc.). For example, one provider terminal may only be able to view the data in the EMR, while a second provider terminal may be limited in accessing EMR data, while a third provider terminal may be able to have full access to an EMR such as to be able to add, delete, edit, etc. data in the EMR.

According to the conventional systems, if a patient sought healthcare services at a medical clinic in a remote area (geographically far from a large medical facility), then the remote medical clinic had limited capability of their services to the patient, even if there is general doctor at the medical clinic in the presence of the patient. For example, the general doctor at the medical clinic may realize that the patient needs special medical services that are beyond the scope of that general doctor; and that the patient needs to visit a large medical facility (for example, at a university, medical center, a hospital, or any other medical entity capable of providing that service to the patient) or a specialist healthcare provider (such as a specialist doctor). According to the conventional systems, the patient would have had to leave the medical clinic without having received the special medical services, and then would have to personally visit the medical facility/specialist that had the capability to provide that medical service. The conventional system has numerous disadvantages such as unnecessary delay in medical service, higher cost, higher burden or even worse that the patient may remain un-serviced.

The method, system and apparatus according to exemplary embodiments of the present invention overcome at least these and other disadvantage in the convention system. Utilizing the method, system and apparatus according to an exemplary embodiment of the present invention, the general doctor, as in the remote medical clinic scenario (above), initiates a healthcare session via a communication network with one or more remote healthcare provider terminal at a larger medical facility or specialist (for example, in another city) to provide healthcare services to the patient without the patient having to leave the clinic. This provides the benefit of efficient, cost-effective and speedier healthcare services to the patient, than the conventional system.

In the remote clinic scenario, exemplary embodiments and/or implementations of the present invention provide a method, system and apparatus for delivering healthcare services to a patient at the medical clinic without the patient having to leave the clinic and without physically going to another facility or specialist. Specifically, the general clinic doctor can establish a healthcare session at the clinic, by utilizing an exemplary method system and apparatus of the present invention, with a remote entity or healthcare provider to provide further healthcare services to the patient. For example, the doctor at the medical clinic, utilizing an exemplary embodiment of the present invention, initiates a session with a remote healthcare provider terminal, take measurements and/or make notes based on observations of the patient at the clinic, and store the measurements/notes in the patient's EMR, which is displayed in an examination session GUI at the computer terminal at the medical clinic. Simultaneously, the remote provider terminal engaged in the same session can simultaneously observe the patient in a GUI. The remote provider can observe the patient via a live (or near-live) video, observe the notes stored by the clinic doctor, and the data in the patient's EMR, via the server. The doctor and patient at the medical clinic can also see and communicate with the remote doctor in the GUI at the medical clinic terminal. If any medical devices take data measurements at the medical clinic terminal (either via an examination station or via medical devices connected to the medical clinic terminal, then those measurements are stored in the patient's EMR at the server and are displayed at the remote provider terminal.

According to one implementation/embodiment of the present invention, if the patient is in physical presence with the general clinic doctor at the clinic, the clinic doctor can initiate and facilitate a healthcare examination session between a computer terminal at the clinic (the terminal being utilized as a recipient terminal 120) and a doctor at the remote provider terminal 130, via the server.

According to another embodiment of the present invention, regardless of whether the patient is in physical presence with the general clinic doctor, the clinic doctor can initiate a healthcare consultation session between a computer terminal at the clinic (the terminal being utilized as a provider terminal 130) and a doctor at the remote provider terminal 130, via the server.

According to another embodiment of the present invention, if the clinic has an examination station 140, and if a patient in physical presence with a general clinic doctor, then the clinic doctor can initiate and facilitate a healthcare examination session between the examination station 140 and a doctor at the remote provider terminal 130, via the server.

FIG. 10 shows a healthcare third-party service session 1000 between one or more healthcare third-party terminals 160 and the server 110 wherein the server generates one or more GUI 1010 for each third-party terminals 160, according to an exemplary method, system and/or apparatus of the present invention. A healthcare third-party terminal comprises an authorized healthcare third-party entity terminal (such as a computer, laptop, mobile phone, mobile computer, mobile electronic device, . . . ) providing information related to healthcare service for a recipient or provider (for example, information from a pharmacy, a laboratory, a health insurance entity, a hospital, any administrative entity)(in addition to a patient, or doctor). A recipient terminal can also engage in a third-party service session with the server. For example, a patient utilizing a recipient terminal can interact with/access the server to access their administrative information (such as address change) or the patient's EMR/PHR, even without having another party engaged in the session with a provider. In another example, a provider terminal can engage in a service session with the server. For example, an authorized doctor utilizing a provider terminal can interact with/access the server to access a patient's administrative information or EMR without having a patient engaged in a session.

Once a service session is established by a terminal (service terminal, recipient terminal, and/or provider terminal), other parties/entities can also join the service session. For example, once an authorized session is established on the server by a third-party entity terminal accessing a patient's information (administrative or EMR), the entity terminal can request adding additional authorized parties into the session (such as other third party entities, a doctor, the patient, insurance company, hospital, . . . ). If each party has a video camera at their location, then a GUI 1010 is established by the server and displayed at the terminal of each authorized party on the session, wherein each GUI displays information based on access privileges for that party. For example, an authorized party (such as a pharmacy) can establish a healthcare services session, via the server, and invite other parties to join (such as a doctor or a laboratory) in that same session, and access the patient EMR with appropriate authentication and privilege.

The server maintains a database comprising recipient's medical information in an EMR and/or PHR, along with access privileges for each data item in the records. The EMR and/or PHR are stored in a database storage at the healthcare server, and are simultaneously accessible by multiple authorized users upon authentication.

The EMR, stored in the database storage connected the server, provides medical information related to a patient comprising data items based on the patients medical history, observations by doctors, information from third parties, and/or any other data items related to the patient's medical care. The EMR, stored in the database on the server, is accessible to any authorized user via a secure 128 bit SSL encryption connection via communication network. The EMR provides the benefit of portability and ease of use for providers to consult regarding a patient, because multiple providers can simultaneously access a patient's EMR even if the providers are geographically/physically remote from each other. The EMR provides numerous benefits including but not limited to drug interaction tables, e-prescriptions, direct connection to laboratories and diagnostic services, and practice management tools, and web based scheduling.

The PHR, stored in the database storage connected to the server, allows patients to access a summary of the their medical history via 128 bit SSL encryption connection via a communication network. Authorized users can access a patient's PHR stored in the database on the server to schedule appointments with a service provider, conduction secure message sessions between service providers and patients, manage prescriptions and refills, and educate patients of medical records and office visits.

An EMR/PHR comprises various data items with access privileges for each data items so only the authorized users can access the data items in the EMR/PHR. The EMR/PHR comprise data items that are not intended to be accessed by everyone that can access the EMR/PHR. For example, a pharmacy may access a patient's EMR to obtain just enough information to verify a patient's allergies but does not need information regarding a patient's blood sugar reading. The server provides a services session with enough access privileges to the pharmacy to obtain the patient's allergy information without providing the pharmacy with the patient's blood sugar information. Additionally, the server provides a services session with access privileges to a laboratory to deposit data into a patient's EMR without allowing the laboratory to access any further information beyond patient authentication.

Any authorized user of the healthcare server can make an appointment with another authorized user of the healthcare server, via the healthcare appointment module 245. The appointment module 245 accesses the EMR/PHR and provider data stored in the database on the server. Any authorized user on the server can make an appointment using their respective GUI at their respective terminal. For example, a doctor accessing a patient's EMR on the server, can make an appointment with another doctor, patient, and/or third party (lab, pharmacy, hospital, university, . . . ) by invoking an appointment functionality on their respective GUI, via the appointment module. The appointment module 245 makes appointments for any session for any authorized user on the server, and also stores information according to appointments in the database on the server. For example, appointment module 245 stores data from each appointment. User's at their respective GUI's at their respective terminals (recipient, provider, third-party, . . . ) can view appointments in a calendar (daily, monthly, hourly, . . . ) and store information in the database, from any appointment.

According to an exemplary embodiment of the present invention, a recipient can make a payment for healthcare services in the GUI at the recipient terminal, which is processed by the payment/financial module 246. For example, if a patient seeks healthcare delivery services according to an exemplary embodiment of the present invention, the patient can enter a form of payment in the GUI at the recipient terminal (such as credit card information, insurance information, bank information, . . . ). The payment module 246 provides an authorization prior to delivery of healthcare services and establishing a healthcare session.

Exemplary embodiments and/or implementations of the present invention provide for generating numerous forms. The server renders various electronic forms on GUI's for respective users of the server (recipient, provider, third party entity, organization, . . . ). The server receives the form data gathered from the respective electronic forms at the GUI's and stores the data in the database at the server. Patient related data is stored in the patient's EMR/PHR, the providers record, the third party service providers record, and/or in any other respective storage for the data item). An authorized user utilizing a respective GUI rendered by the server can also upload an image of a paper form for storage in the database on the server. For example, if a patient has a paper document (such as a form, report, notes, pictures, drawings, etc) comprising information regarding the patient, the patient can scan the form at their respective terminal, and using their respective GUI, upload the scanned image of the document into the database on the server (in the EMR/PHR). The electronic forms comprise GUI functions to receive information inputted by users into the electronic form (such as radio buttons, pull-down menus, text fields, . . . ). The data gathered from the electronic forms is stored in the respective records on the database in the server. For example, data gathered on an electronic form on a GUI at a recipient terminal (or a provider terminal) is saved in the database on the server. Medical information of gathered from the form is stored in a recipient's EMR/PHR. Information gathered by a provider at the provider terminal is saved in the provider database on the server.

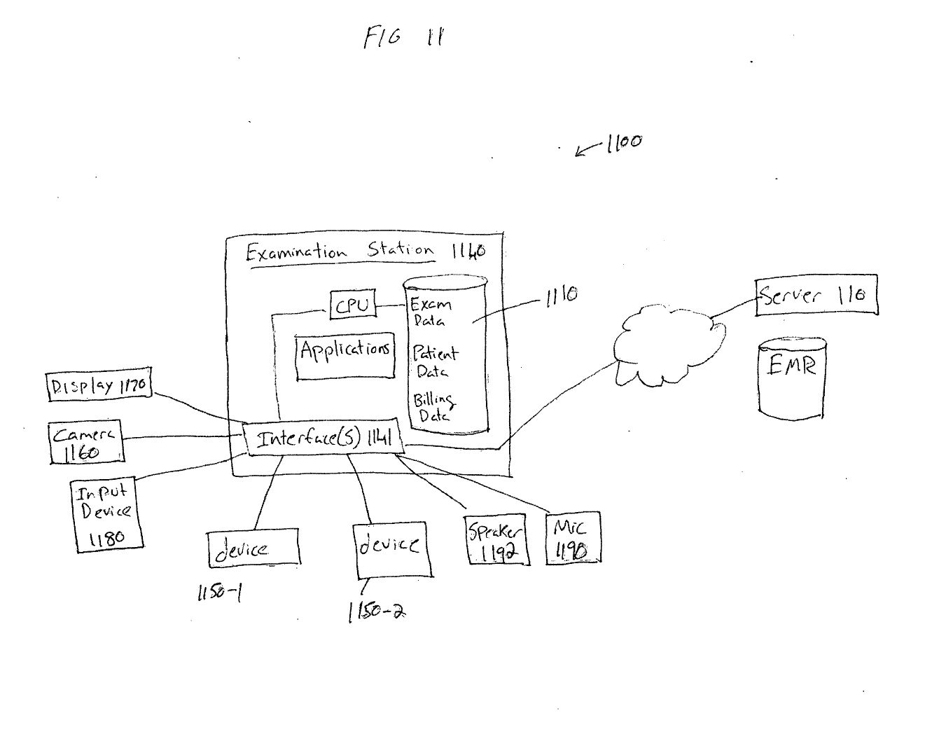

FIG. 11 shows a healthcare examination system 1100 according to an exemplary embodiment of the present invention comprising a healthcare examination station 1140 comprising a examination station data storage 1110, at least one interface(s)1141 coupled to one or more medical devices 1150 (1150-1, 1150-2, 1150-3, 1150-4, . . . 1150-n), one or more video camera devices 1160, one or more display devices 1170, one or more user input devices (such as mouse, joystick, and/or keyboard) 1180, and/or one or more audio devices (microphone 1190, speaker 1192), via a wired or wireless connection (such as Bluetooth). The examination station 1140 comprises one or more cameras that capture video images of a recipient's examination. These video images are displayed at a display device 1170 at the station in real-time and stored in the examination station data storage 1110.

According to an exemplary embodiment of the present invention the data stored in the examination station data storage 1110 is reviewed by a provider (such as a doctor or another healthcare provider) at a later time using the examination station 1140, or another computer implemented device coupled (wired or wireless) to the examination station 1140. This can be called a store-and-forward examination that provides the benefit of conducting an examination of a recipient at an examination, storing the results of the examination at the examination station data storage, such that a provider can access the results at a later time at the same examination station without the results having to be transmitted over a communication network. Exemplary embodiments of the present invention provide the benefit of utilizing the examination station 1140 in the examination system 1100 at a facility (such as a clinic, hospital, doctor's office, . . . ) that is not connected to a communication network. Also, Exemplary embodiments of the present invention provide the benefit of utilizing the examination station 1140 in the examination system 1100 to conduct an examination of a patient without the doctor's presence, and allowing the doctor to review the data from the examination at a later time. The patient and doctor do not have to be engaged in the examination at the same time.

According to an exemplary embodiment, the interface 1141 is connected to the healthcare server 110 via a telecommunication network 102 such as to send and/or receive data and command signals to/from the server 110.

According to an exemplary embodiment of the present invention, using the health care examination station 1140 in examination system 1110, the data stored in examination data storage 1110 can be transmitted/sent to the server 110, and displayed at the provider terminal either in real-time/live (or near real-time/live) for simulating an (near) in-person face-to-face healthcare session between the examination station 1140 and a healthcare provider, via the server 110, or in delayed time so a provider can examine the patient's examination data at a later time. The data stored in the data storage 1110 can also be transmitted to the server 110 and stored in the recipient's data storage 220 connected to the server. For example, video images are taken of a recipient at examination station 1140, and stored in examination station data storage 1110. The video images are later (or in real time) transmitted to the server 110. The video images are stored in the recipient's EMR (discussed below) in the recipient's data storage 220 connected to the server 110. If a provider is in an examination session with recipient using examination station 1140, the provider terminal comprises/interfaces with one or more provider input devices 191 (such as a mouse, joystick, and/or keyboard, etc.) to receive a provider command signals to control functions at the examination station, via the server 110. The provider terminal receives a provider command signal from a provider user via the provider input device, transmits the provider command signal to the examination station via the server. The examination station gateway sends, via interface(s) 1141, the provider command signal to the appropriate medical device 150 to execute the command signal(s). The command signal comprises one or more to control functions of the medical devices and/or camera, allowing a remote provider to control the devices/camera to provide services on the recipient, via the server 110. For example, a provider, connected to the examination station during a session with a recipient, can control the video camera(s) and/or devices mounted on the examination station by sending command signals. If a doctor wants to zoom the camera in closer to a patient's body part, the doctor can send a command (such as a joystick command) to zoom the camera. The command signals comprise data and/or power control signals.

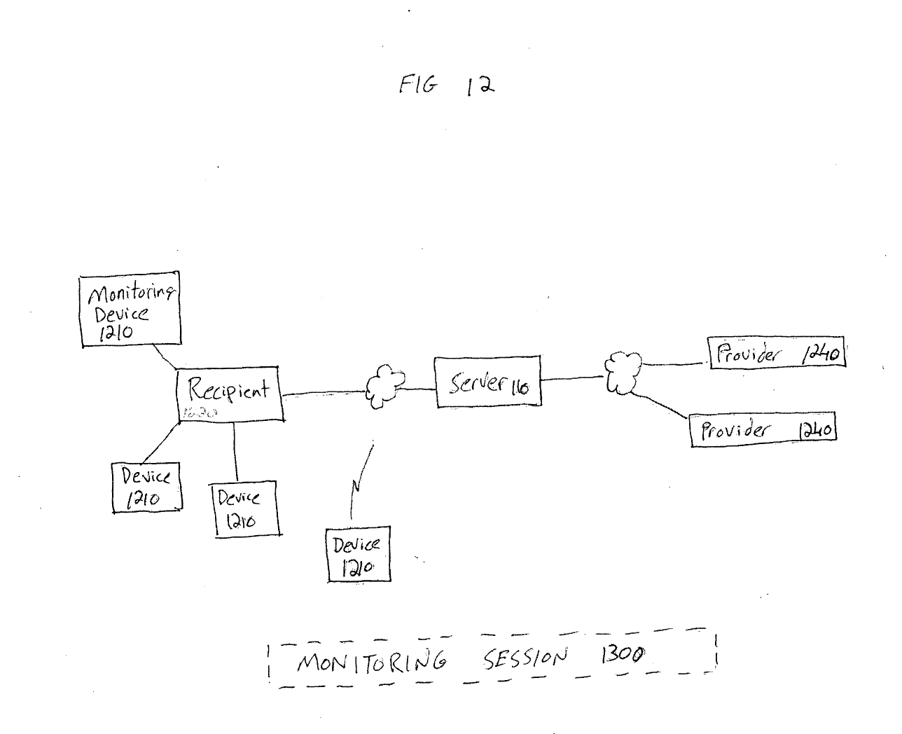

FIG. 12 shows a healthcare monitoring system 1200 according to an exemplary embodiment of the present invention comprising one or more recipient monitoring devices 1210 is connected to a provider terminal 1240 via server 110 over a communication network. The recipient monitoring device 1210 is coupled (via wired or wireless connection) to a recipient terminal 1220 connected to the server 110 over a communication network (such as Internet, Intranet . . . ). One or more monitoring device 1210 gather data from a recipient, and then the data is transmitted to the provider terminal 1240 in real time (or near real-time), via the server, such as to establish a live/real-time (or near) healthcare monitoring session 1300 between a recipient using the monitoring device 1210 and a provider at the provider terminal 1240. The data gathered by the monitoring device 1210 in a monitoring session is stored in the recipient's EMR 220, via the server, and/or stored at the monitoring device for later transmission to the EMR. Monitoring device(s) 1210 is coupled to a recipient terminal 1220 that is connected to the server over a communication network. According to an exemplary embodiment of the present invention, monitoring device 1210 is standalone, without necessarily requiring being coupled to a recipient terminal, and in which case the monitoring device 1210 is connected directly to the server over a communication network (without the intervening recipient terminal).

Further, according to an exemplary embodiment of the present invention, the server 110 establishes a monitoring session between one or more monitoring devices 1210 and a provider utilizing a provider terminal 1240, such that the provider sends commands/instructions using an input device 191 (joystick, keyboard, microphone, . . . ) to control the monitoring device 1210 (either directly to the monitoring device or to the monitoring device via a recipient terminal 1220), via server 110. Monitoring device 1210 comprises a device from one or more electronic or mechanical devices that examines a recipient (medically monitor) or perform functions to a recipient (such as medical functions), and transmits data/information to the server. For example, healthcare monitoring device 1210 comprises a device such as but not limited to a heart rate monitor, blood sugar monitor, breath monitor, bio-feedback monitor, blood pressure monitor, breathalyzer, etc.

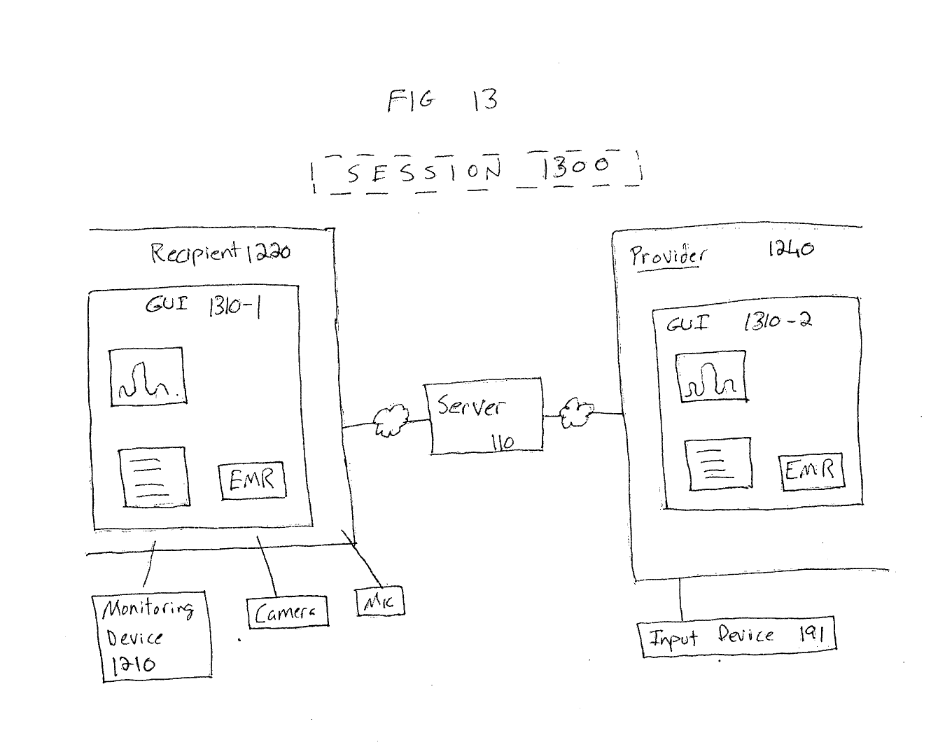

FIG. 13 shows a method, system and apparatus for a healthcare monitoring session 1300 between one or more recipient monitoring devices 1210, and at least one healthcare provider terminal 1230 via the server 110. The monitoring device 1210 is coupled to a recipient terminal 1220 that is connected to the server via a communication network. The server 110 generates one or more graphical user interface(s)(GUIs) 1310-1, 1310-2 at each respective recipient terminal 1220 and provider terminal 1240. For example, a patient and a recipient can be engaged in a healthcare monitoring session 1300 to measure the patient's heart rate under various stimuli. According to an exemplary embodiment of the present invention, a patient at home can be attached to a heart monitor (monitoring device 1210) to measure the patient's heart rate under various real-time stimuli from a doctor. The heart monitor receives heart rate data by taking readings from the patient and transmits the heart rate data from the heart monitor to the server. The server receives the heart rate data from the heart monitor and transmits the heart rate data to a doctor at a provider terminal. If the doctor sends stimuli control commands for the heart monitor from the provider terminal, the server receives the control commands from the provider terminal and transmits the stimuli control commands to the heart monitor to execute stimuli on the heart monitor. The control commands can control the stimuli executed by the heart monitor such as to provide a real-time (or near) control of the heart monitor by the provider to monitor the patient's heart rate under varied stimuli. The data gathered from the heart monitor is stored in the patient's EMR, via the server, in addition can be stored at the heart monitor and/or a recipient terminal coupled to the heart monitor.

The healthcare deliver system, according to exemplary embodiments of the present invention, provides a single source solution providing all the necessary components to implement a successful telemedicine program. The platform is designed for ease of use and is compliant with all Health Level Seven (“HL7”) infrastructures, including the following features:
1. Web-based Meaningful Use Certified Electronic Medical Record (EMR), containing
practice management tools as needed
2. Web-based High Definition Video Conferencing
3. Patient Personal Health Record (PHR)

According to exemplary embodiments of the present invention, the systems are Health Insurance Portability Accountability Act (“HIPAA”) compliant, adhering to all industry standards for the secure transmission of medical data between providers and patients. The health deliver method, system and apparatus, according to an exemplary embodiment of the present invention utilizes 128 bit encryption to secure health data transmission and storage.

The health deliver method, system and apparatus, according to an exemplary embodiment of the present invention, can be accessed via a telecommunication network (i.e., Internet) by recipient users and/or medical provider users through a desktop computing device, mobile computing device, a kiosk computing device, and/or a tablet computing device, at anytime resulting in improved access to network physicians, reduction in out of network utilization, improved quality of care, improved continuity of care and at the same time reducing medical costs.

The health deliver method, system and apparatus, according to an exemplary embodiment of the present invention, provides numerous benefits/advantages including (but not limited to) the ability to provide an efficient healthcare delivery model and reduce medical costs while at the same time improving the quality of care. For example, the health deliver method, system and apparatus, according to an exemplary embodiment of the present invention provides for groups or organizations to use our revolutionary technology and web platform for your own existing patients and physicians.

The healthcare deliver method, system and apparatus, according to an exemplary embodiment of the present invention, provides for utilization by a network of providers by providing medical providers with the infrastructure and tools necessary to create a successful and robust tele-health, e-health, etc., practice.

Further, exemplary embodiments and/or implementations of the present invention provide various features, benefits and/or advantages for patients, health care providers (i.e., doctors, and/or any health care providing entity, . . . ), employers, and/or healthcare networks.

### A. Patients—Routine Care

The health deliver method, system and apparatus, according to various exemplary embodiments/implementations of the present invention, provides at least for the following features, benefit and/or advantages:
Visit with a healthcare provider from the convenience of recipient's home or office
No transportation necessary to see your doctor
Avoid contagious illness associated with crowded ER's and doctor's offices
Improve access to Board Certified physicians and specialists
Access to patient's own real-time Personal Health Record (PHR) anywhere, anytime
Secure and trusted medical record keeping compliant with all health care standards
Access to quality care at a fraction of the cost of a traditional healthcare visit
Networked pharmacies provide you discount rates on medications delivered directly
Consultations with specialist physicians across the country for second opinions on medical illness
Avoid long waits often associated with hospitals and offices
Ability to provide remote medical monitoring for acute and chronic diseases
Be able to request various diagnostic lab tests such as blood chemistries and cholesterol tests and review them with your physician online
Access using a legitimate email address
Payment using a credit or debit card for payment processing
Delivery over High-speed broadband/wifi Internet connection
Utilize Webcam with 1.3 megapixel resolution or better
GUI via current web browser including (but not limited to) Internet Explorer 7+, Google Chrome 4+, Safari 4+, Apple iOS 4+, Android 3+, or Mozilla Firefox 3.5+Communication via VoIP Headset or standard desktop speakers and microphone

According to exemplary implementations and/or embodiments of the present invention, a recipient user (patient) can seek medical attention/consultation from a provider user (i.e., medical providers such as doctors, physicians and/or other medical professionals), utilizing exemplary embodiments of the present invention, to consult on various health issues, including but not limited to the following health issues:

Acute Illness
Allergic Reactions
Ear Infections
Cough
Eye Infection/Injury
Flu
Headache
Rashes/Poison Ivy
Skin Infection
Sinus Infection
Sore throat
Urinary Tract Infection
Vomiting and Diarrhea
Ongoing Healthcare
Acne
Allergies
Hypertension
Diabetes
High Cholesterol
Acute Injuries
Back Pain
Bites
Bruises
Lacerations
Minor Burns
Sprains and Strains
Travel Medicine Services
Medication and Travel Precautions
Mental and Behavioral Services
Anxiety
Depression
Marital Issues
Mental Health
Stress
Child Behavior Issues
Eating Disorders
Smoke Addiction/Cessation
Substance Abuse

Exemplary embodiments/implementations of the present invention provide for various patient membership options. For example, the healthcare delivery system offers various medical plans designed to suit a patient's budget and healthcare needs. A person seeking medical attention (i.e., a patient) can acquire a membership to utilize the healthcare delivery system and then purchase a visit to see a healthcare provider (i.e., physician) utilizing the method, system and/or apparatus according to an exemplary embodiment of the present invention, or the patient can see a physician visit/consultation (via the healthcare delivery system) without a membership by utilizing the non member visit options.

Further, exemplary embodiments/implementations of the present invention provide for various patient access plans (for obtaining medical services via the healthcare delivery system). For example, a patients can access the healthcare deliver system via:

(a) an Individual Patient Plan—where patient can have membership for a limited time period (i.e., per month or per year) and can pay a secondary cost per visit (a cost that can be lower than a single visit plan with no membership), for access to a medical provider;

(b) a Family Patient Plan—which can cover a fixed number of people living at the same address;

(c) Single Visit Plan—where patient pays per visit;

(d) Travel Membership—Travel Membership includes all of the benefits of the standard membership and can be purchased temporarily to cover your medical needs while traveling on business or vacation. From the convenience of a computer terminal connected to a communication network, a healthcare recipient can visit and be treated by a United States physician from anywhere in the world; and/or

(e) Concierge Membership—Concierge Membership includes all of the benefits of the standard membership and can be purchased to supplement a recipient's existing medical coverage. From the convenience of a connected computer or phone, a recipient can be treated by a licensed physician at anytime and anywhere.

(f) Group Membership (Employee Group, Organizations, and Government Agencies)—the healthcare delivery system offers various group medical plans. These plans can be customized to suit the needs of any group or organization, and discount options are available depending on healthcare needs and services.

According to various exemplary embodiments/implementations, the healthcare delivery method, system and apparatus according to exemplary embodiments of the present invention provides for the following features:

To Schedule an Appointment For Recipient:
1. Login to your personal health record and click on the provider tab to select a provider and appointment time.
2. Briefly describe the nature of your illness in the text box and submit your information to confirm your appointment.
3. Record your personal four digit access code to enter your provider's office.
4. Five minutes before your appointment, enter patient login and click on doctor's office.
5. Once you enter your personal four digit access code, you will have arrived into the doctor's office. The doctor will see you now.

### B. Providers (Doctors; Medical Providers)

Exemplary embodiments/implementations of the present invention provide for the following features, benefits and/or advantages to healthcare providers (such as medical doctors):
1. increasing a practice's revenue
2. expand a current patient base without hiring additional staff or investing additional capital
3. a provider with multiple states license looking to increase your patient base
4. maximize the number of patients a provider sees in a day
5. a retired physician or nearly retired physician can make extra income while continuing to practice medicine
6. allowing a physician interested in working from anywhere in the world
7. allowing a hospital physician seeking additional days off
8. facilitating a physician who would like to create a virtual practice
9. allowing a physician to have a flexible schedule

### C. Entity Health Care (Such as Employer and Employee Services)

Exemplary embodiments of the present invention provide for on-site employee evaluations and other occupational services. For example, if an employee needs medical attention while physically on-site at the employer's locations, then the employer provides an examination station, a kiosk and/or portable computer that executes the healthcare delivery method and system to provide an initial and immediate medical care to the employee. The employee, via the healthcare delivery system, can be instantly connected to a physician (in real or near-real time) to evaluate the employee's medical issue. The healthcare delivery system maintains an EMR of the evaluation (including but not limited to a video record, a medical diagnostic record, drug prescription record, treatment record, or any other medical record). The computer device implementing the healthcare delivery system can be connected to various peripheral medical diagnostic devices that monitor or record statistics based on evaluation of the patient (i.e., blood pressure, heat beats, . . . ).

Exemplary embodiments/implementations of the present invention provide for the following features, benefits and/or advantages to entities and/or organizations (such as employers, business entities and/or government departments/agencies).

Exemplary embodiments and/or implementations of the present invention, utilizing the healthcare delivery system provide for an “anywhere and anytime” solution to organizations' healthcare needs. For example, the well-trained, Board-Certified physicians provide around-the-clock care to keep patient-employees at any employer location (staff and employees) healthy by offering preventative medical services as well as urgent/needed care in times of sickness. Patients-employees consult the providers and physicians by streaming video, e-mail, telephone, or even a kiosk within and entity's premises, providing them convenient access to healthcare and stress/behavioral therapy. A visit with one of our doctors will often result in a discussion of symptoms and diagnoses with a treatment plan or prescription as needed. According to exemplary embodiments of the present invention, all data derived from a consultation/session, utilizing the health delivery system, are recorded and maintained in a patient's EMR. The EMR/PHR can be implemented by utilizing any commercially available database management system (i.e., Oracle, Sybase, . . . ) to store and manage the patients' EMR/PHR.
As a result, the healthcare delivery system according to exemplary embodiments of the present invention, will save an organization significant costs associated with unnecessary lost days of work/absenteeism and visits to the Emergency Room. The session's/visit's approximate that of many insurance co pays, are less than almost all deductible plans, and often qualify for HSA/HRA reimbursement. Moreover, productivity in the work place is much improved, and employee's job satisfaction is enhanced as they have an additional important benefit—access to care anywhere and anytime.
Physician interactions are available from home or work via video and web camera, instant messaging, e-mail, telephone, or even full-service examination stations and kiosks within any premises
Urgent Care services available from a home or workplace
Routine consults and wellness programs to keep employees healthier
Physicians provide a comprehensive diagnosis and treatment plan, which may include a prescription sent electronically to a local pharmacy
Networked laboratories so that patients may go to their local laboratory for any necessary diagnostic testing

Exemplary embodiments of the present invention provide for various benefits, including but not limited to:
a. Reduce health insurance premiums by seeing doctor online
b. Our costs equate insurance co-pays, less than deductible plans, and qualify for HSA/HRA reimbursement
c. Cost savings due to reduced absenteeism and visits to the ER
d. Improvement in workplace productivity and job satisfaction
e. Employers can save up to 15% of payroll on reduced absenteeism.
f. Employers can save 25% of healthcare benefit costs.

### D. Healthcare Networks—The Solution for Healthcare Networks, Medical Groups, and Payers

Exemplary embodiments and/or implementations of the present invention provide the following features and/or advantages to healthcare organizations networks, groups, and/or payors.

According to exemplary embodiments and/or implementations, conventional technology has numerous drawback and complexity in delivering healthcare services and care. Providers strive to provide world-class care while systems and organizations successfully integrate this care so that patients are well served. Therefore, exemplary embodiments and/or implementations of the present invention provide for the ability of a patient to see their healthcare professional remotely via the web or “cloud”, along with supplemental benefit to allow patients to consult with their routine office or hospital visits. According to exemplary embodiments of the present invention, the healthcare delivery method, system and apparatus will improve access to physicians and other healthcare providers at a time when patients are unable to physically see a provider. Additionally, these and other benefits of exemplary embodiments and implementations of the present invention provide for tremendous cost savings as a result of unnecessary hospital visits (i.e., emergency room) or doctor's offices. For example, a patient seeing medical attention can avoid a trip to the healthcare provider because, by utilizing various exemplary embodiments of the present invention, a patient can better informed and counseled by a physician online visit.

As a result, for example, groups and/or organizations utilize the healthcare delivery method, system and apparatus according to exemplary embodiments and/or implementations of the present invention to provide a Web based platform for patients and physicians. The healthcare delivery system is dynamic, robust, and well supported so that that the delivery of healthcare is maintained and secure.

Additionally, according to exemplary embodiments and/or implementations of the present invention, a doctor can remotely perform medical procedures (such as surgery, physical examination, . . . ) on patients as if the doctor was geographically present with the patient, retain electronic medical records related to the medical procedure performed. For example, a doctor logged into a session on the healthcare delivery system from geographic Location B can remotely perform medical procedures on a patient logged into the healthcare delivery system from geographic Location A, by utilizing medical equipment (such as robotic equipment at the patient's and/or doctor's locations) that is also connected to the healthcare delivery system. As the doctor engages in the medical procedure (such as a surgery), the medical equipment (located at the patient's and/or doctor's site) provides the healthcare delivery system with information and data points from the surgical procedure. The healthcare server receives the information and/or data points, and record it into the patient's EMR at the healthcare server. Additionally, according to exemplary embodiments and/or implementations of the present invention, a medical provider (such as a doctor, laboratory, physician's assistant, nurse, ambulance, . . . etc.) can conduct a consultation/session with another medical provider that is at a remote geographical location. For example, a doctor logged onto the healthcare delivery system from remote Location B can share a patient's medical information and/or data, via the healthcare server, with a doctor at Location A, and further, the healthcare server can store the information/data in an EMR at the database management system. For example, the doctor at Location B can share audio, video, pictures, data points from one or more medical devices (e.g., blood pressure monitor, heart rate monitor, blood sugar monitor, . . . ) with a doctor at Location A.

Exemplary embodiments and/or implementations of the present invention provide a healthcare delivery method, system and apparatus for a comprehensive portal to implement a level-five telehealth program. The service provide for ease of use and compatibility with all HL7 compliant systems, solutions, and platforms. The healthcare delivery system revolves around an integration of a multi-user cloud-based video conferencing system with white board capabilities. It incorporates a file share technology, a meaningful-use web-based Electronic Medical Record (EMR), Personal Health Record (PHR), and additionally, direct real-time access to laboratory, pharmacy, and technical services 24 hrs/7 days weekly.

According to an exemplary embodiment of the present invention, a patient seeking healthcare services accesses healthcare server 110 by utilizing a graphical user interface such as a Web browser or a stand alone computer application. If the patient is using a Web browser, they enter a URL address to access the healthcare server 110 and provide information in the Web browse. If the patient is using a stand alone computer application, they trigger the application to access the healthcare server 110 and provide information in a graphical user interface. The patient either have an immediate visit with a doctor provider if one is currently available on the network, or the patient can schedule a visit with any doctor or provider in the network. Once a patient and doctor are securely authenticated into a session, the doctor can conduct an examination of the patient, utilizing the exemplary method, system and apparatus of the present invention.

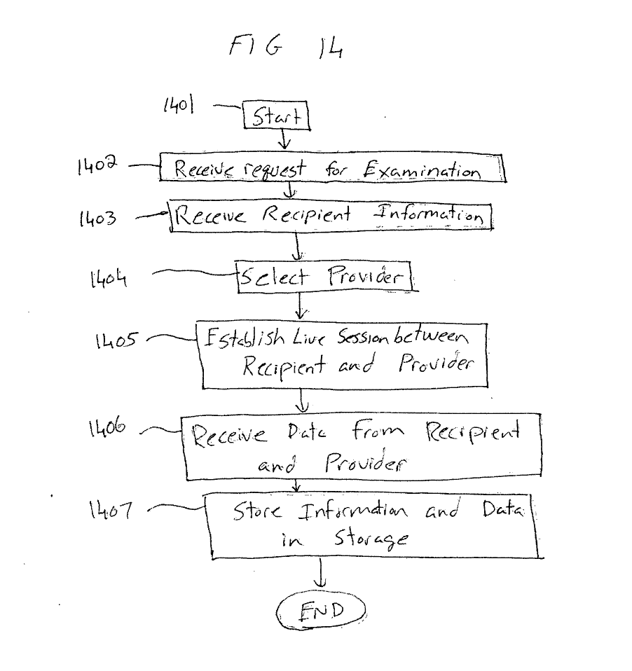

FIG. 14 shows a flow diagram of an examination session between a recipient terminal and a provider terminal via the server, according to an exemplary system, method and/or apparatus of the present invention. For example, if a person is sick, they can initiate a session 1401 by establishing a communication session with the server requesting an examination. The server receives the request for examination 1402, receives information from the recipient 1403 (such as background information, address, allegories, . . . ), selects a suitable provider 1404 (by matching criteria from the patient to select a suitable doctor to treat that patient's condition), once doctor is selected, establishes a live session between a recipient and provider 1405 (such as a video conference, virtual private network) such that recipient and provider can access the recipients EMR, receive data from a recipient and provider 1406 (such as data gathered during examination, notes, readings) and storing the information and data in storage 1407.

The above-described exemplary embodiments of an apparatus, system and method in transitory and/or non-transitory computer-readable media include program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include transitory and non-transitory magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and so on, including a carrier wave transmitting signals specifying the program instructions, data structures, and so on. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although exemplary embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

1. An apparatus for providing services between a recipient and a provider via a server over a communication network, the apparatus comprising:
a computer implemented processor configured for:
establishing a recipient session connection between a first terminal and said processor, over the communication network;
receiving recipient information from the first terminal, via the session connection;
establishing a provider session connection between a second terminal and said processor, over the communication network
receiving provider information from the second terminal, via the session connection;
establishing an examination session connection by connecting the recipient session connection with the provider session connection;
storing the recipient information in an first database record, as stored recipient information;
storing the provider information in a second database record, as stored participant information;
transmitting recipient information to the second terminal via the examination session connection;
displaying selective recipient information in a first graphical user interface (“GUI”) at the first terminal and in a second GUI at the second terminal; and
displaying selective provider information in the first GUI and in the second GUI,
wherein said recipient information comprises information received at the first terminal including audio-video data,
wherein said provider information comprises information received at the second terminal including audio-video data
wherein the recipient session connection comprises a virtual private network between the processor and the first terminal,
wherein the provider session connection comprises a virtual private network between the processor and the second terminal,
wherein the examination session connection comprises a virtual private network between the first terminal and the second terminal via said processor.

2. The apparatus of claim 1, wherein the examination session connection comprises a real-time/live (or near real-time/live) connection.

3. The apparatus of claim 1, wherein recipient information further comprises one or more of a data received from an input device, information received from one or more instruments.

4. The apparatus of claim 1, wherein participant information further comprises one or more of a data received from an input device, information received from one or more instruments.

5. The apparatus of claim 1, wherein the communication network comprises one or more of a local area network, a wide area network, a world wide web network, an Intranet network, and an Internet network.

6. A method for providing healthcare delivery services over a communication network, the method comprising steps for:
establishing a recipient session connection between a first terminal and said processor, over the communication network;
receiving recipient information from the first terminal, via the session connection;
establishing a provider session connection between a second terminal and said processor, over the communication network
receiving provider information from the second terminal, via the session connection;
establishing an examination session connection by connecting the recipient session connection with the provider session connection;
storing the recipient information in an first database record, as stored recipient information;
storing the provider information in a second database record, as stored participant information;
transmitting recipient information to the second terminal via the examination session connection;
displaying selective recipient information in a first graphical user interface (“GUI”) at the first terminal and in a second GUI at the second terminal; and
displaying selective provider information in the first GUI and in the second GUI,
wherein said recipient information comprises information received at the first terminal including audio-video data,
wherein said provider information comprises information received at the second terminal including audio-video data
wherein the recipient session connection comprises a virtual private network between the processor and the first terminal,
wherein the provider session connection comprises a virtual private network between the processor and the second terminal,
wherein the examination session connection comprises a virtual private network between the first terminal and the second terminal via said processor.

7. A system for providing healthcare delivery services over a communication network, the system comprising:
a computer implemented processor unit configured for:
establishing a recipient session connection between a first terminal and said processor, over the communication network;
receiving recipient information from the first terminal, via the session connection;
establishing a provider session connection between a second terminal and said processor, over the communication network
receiving provider information from the second terminal, via the session connection;
establishing an examination session connection by connecting the recipient session connection with the provider session connection;
storing the recipient information in an first database record;
storing the provider information in a second database record;
transmitting recipient information to the second terminal via the examination session connection;
displaying selective recipient information in a first graphical user interface (“GUI”) at the first terminal and in a second GUI at the second terminal; and
displaying selective provider information in the first GUI and in the second GUI,
wherein said recipient information comprises information received at the first terminal including audio-video data,
wherein said provider information comprises information received at the second terminal including audio-video data
wherein the recipient session connection comprises a virtual private network between the processor and the first terminal,
wherein the provider session connection comprises a virtual private network between the processor and the second terminal,
wherein the examination session connection comprises a virtual private network between the first terminal and the second terminal via said processor. a data storage unit configured for:
storing the recipient information in an first database record, as stored recipient information;
storing the provider information in a second database record, as stored participant information;

8.-12. (canceled)

13. The system of claim 7, further comprising an instrument device coupled to the first terminal such that the instrument device receives monitoring data and transmits said monitoring data to the first terminal.

14. The system of claim 13, wherein instrument device receives monitoring data by receiving said monitoring data from the first terminal coupled to the instrument device.

15. The system of claim 13, further comprising receiving at least one control command from said second terminal, and transmitting said control command to the one or more instrument devices via said processor.

16. The system of claim 13, wherein said monitoring data comprises data received from said instrument device.
